(19) United States
(12) Patent Application Publication
(10) Pub. No.: US 2021/0378391 A1
(43) Pub. Date: Dec. 9, 2021

(54) CASE FOR ELECTRONIC DEVICES

(71) Applicant: Michael Castaneda, Fallbrook, CA (US)

(72) Inventor: Michael Castaneda, Fallbrook, CA (US)

(21) Appl. No.: 16/896,330

(22) Filed: Jun. 9, 2020

(51) Int. Cl. A45F 5/00; H04B 1/3888; H04B 1/3827

(52) U.S. Cl. CPC A45F 5/00; H04B 1/3888; H04B 2001/3861; A45F 2200/0516; A45F 2005/008; H04B 1/385

(57) ABSTRACT

An improved case for electronic devices including a detachable and rotatable hand strap. The improved case is structured and arranged to secure electronic devices therein and to the hand of a user. The detachable and rotatable hand strap offers a full 360° of rotation and thus a more comfortable and reliable grasp to thereby reduce the risk of dropping and damaging the electronic devices.

### CROSS-REFERENCE TO RELATED APPLICATION

There are no related applications incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

The present invention relates generally to the field of protective case devices and more specifically relates to a smartphone casing with an attached, wearable band, or hand strap structured and arranged to secure a cellular smartphone to the hand of the user.

### 2. Description of the Related Art

The market is currently flooded with cell phone accessories that seek to make use of these handy units even more convenient. Compact headsets, featuring a speaker that can be affixed to the ear in addition to an integrally attached mouthpiece, are designed for consumers with busy schedules. Freeing the hands from holding the unit, headsets allow cell phone users to conduct business or personal conversations while attending to other tasks. Additionally, belt clips for encasing devices are very practical, providing a housing for the unit when it is not in use and a sturdy means of storage when the phone is used in conjunction with the headset. However, management problems are exacerbated with slimline smart phones, since these are not kept in a belt clip. With slippery plastic casing and glass fronts, it is not uncommon for these units to easily slip from one's grasp. Should the glass protecting the screen crack or break, it can cost almost as much as a new phone to have it replaced. Moreover, with all the capabilities inherent in smart phones such as Apple's iPhone and Samsung's Android, it is necessary to use both hands to fully operate the device. As can be imagined, trying to send a text message, capturing a candid photo, or simply placing a call can risk one dropping and breaking the equipment. Considering that smart phones are becoming more and more necessary, convenient and reliable means of managing and maintaining these units have become especially important.

Various attempts have been made to solve problems found in protective case device art. Among these are found in: U.S. Pat. No. 8,676,279 to Andy McCurdy; U.S. Pub. No. 20150173497 to David Yu; and U.S. Pat. No. 9,259,077 to Murphy et al. This prior art is representative of protective cases for portable electronic devices comprising a strap.

None of the above inventions and patents, taken either singly or in combination, is seen to describe the invention as claimed. Thus, a need exists for a reliable Grab & Go Phone Case, smartphone casing with an attached, wearable band, or hand strap structured and arranged to secure a cellular smartphone to the hand of the user and to avoid the above-mentioned problems.

### BRIEF SUMMARY OF THE INVENTION

In view of the foregoing disadvantages inherent in the known protective case device art, the present invention provides an improved case for electronic devices. The general purpose of the present invention, which will be described subsequently in greater detail, is to provide a smartphone casing with an attached, wearable band, or hand strap structured and arranged to secure a cellular smartphone to the hand of the user. Offering a hand strap that gives a full 360° of rotation, and thus a more comfortable and reliable grasp thereby reducing droppage and increase comfort by offering consumers a more secure and efficient means of handling and operating these expensive devices. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments according to the teachings of the present invention.

FIG. 1A shows a back perspective view illustrating the improved case for electronic devices according to the preferred embodiment of the present invention.

FIG. 1B shows a front perspective view illustrating a smart phone device to be placed within the improved case for electronic devices according to the preferred embodiment of the present invention of FIG. 1A.

FIG. 2 shows a perspective view of the adjustable strap of adjustable handle of the improved case for electronic devices according to the preferred embodiment of the present invention of FIG. 1A.

FIG. 3 shows a perspective view of the adjustable handle about to be connected to the main body of the improved case for electronic devices according to the preferred embodiment of the present invention of FIG. 1A.

FIG. 4 shows another back perspective view of the adjustable handle about to be connected to the main body of the improved case for electronic devices according to the preferred embodiment of the present invention of FIG. 1A.

FIG. 5 shows a perspective view of the flexible portion of the first connector member being pressed downwardly to deform the first connector member to thereby allow the removal of the second connector member therefrom according to the preferred embodiment of the present invention of FIG. 1A.

FIG. 6 shows a back view of the improved case for electronic devices according to the preferred embodiment of the present invention of FIG. 1A.

FIG. 7 shows a side view of the improved case for electronic devices according to the preferred embodiment of the present invention of FIG. 1A.

The various embodiments of the present invention will hereinafter be described in conjunction with the appended drawings.

### DETAILED DESCRIPTION

As discussed above, embodiments of the present invention relate to a protective case for a smartphone with an attached, wearable band, or hand strap structured and arranged to secure a cellular smartphone to the hand of the user. The hand strap gives a full 360° of rotation, and thus a more comfortable and reliable grasp thereby reducing droppage and increase comfort by offering consumers a more secure and efficient means of handling and operating these expensive devices.

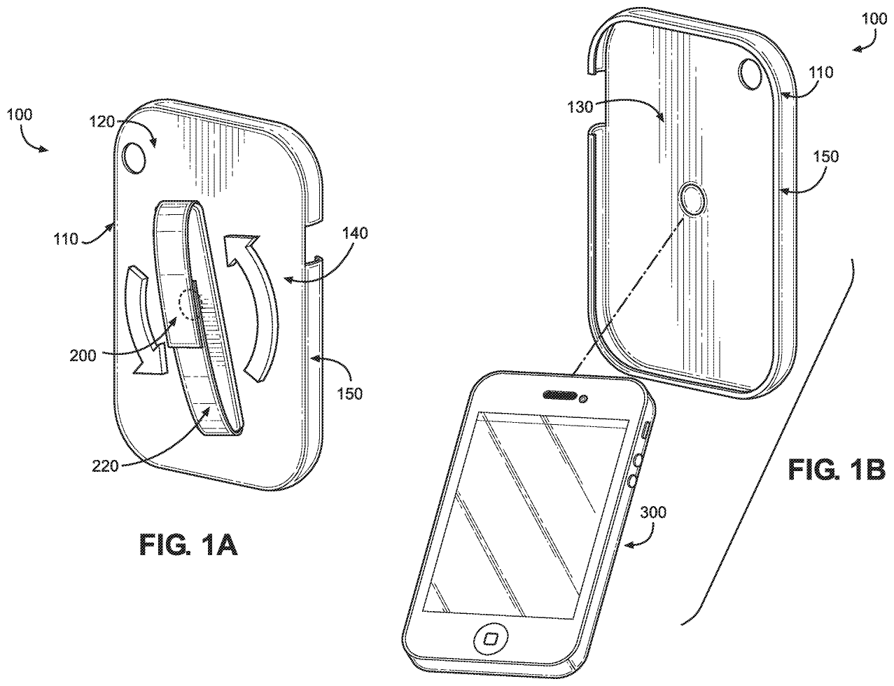

Referring to FIGS. 1A and 1B, the improved case 100 for electronic devices of the instant invention is for holding an electronic device 300 having a body that is usually formed in the shape of a rectangular volume. The preferred embodiment of the instant case 100 comprises a main body 110 including a semi-rigid panel 120 that includes a front surface 130, a rear surface 140, at least one side wall 150, wherein the at least one side wall extends perpendicularly from the semi-rigid panel, wherein the front surface and the at least one side wall form a rectangular volume, and wherein the front surface and the at least one side wall are adapted to releasably and securely hold the electronic device within the rectangular volume.

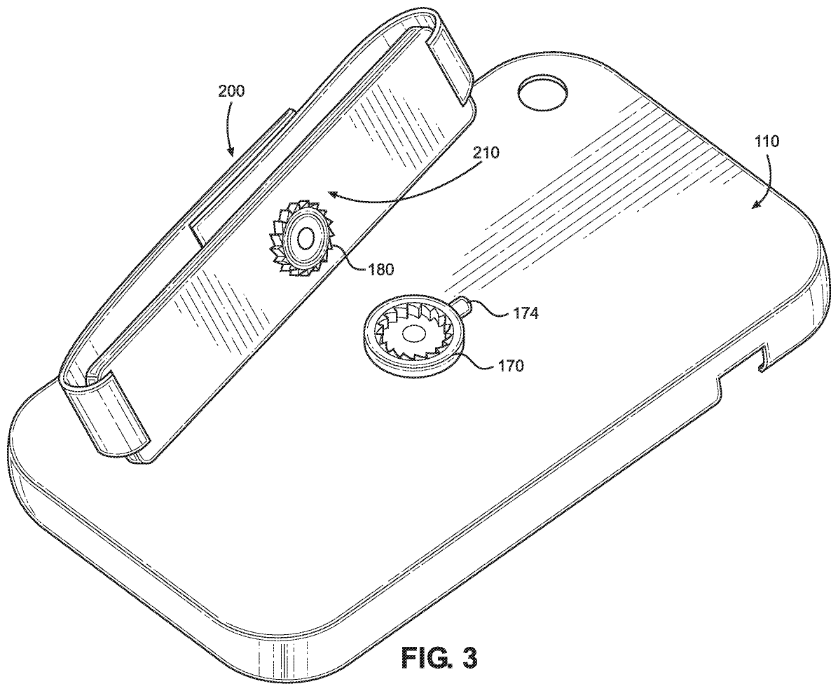

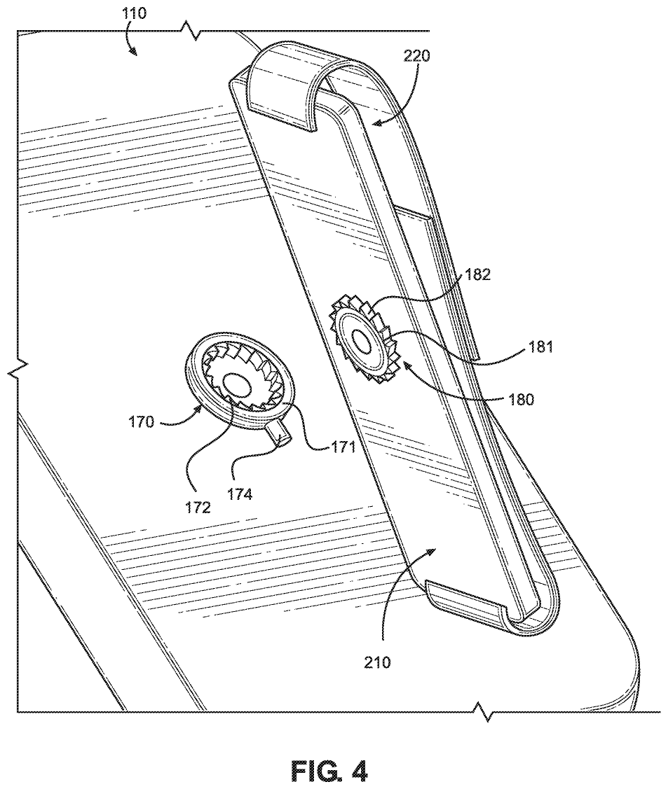

Referring to FIGS. 3-5 a first connector member 170 includes a flexible portion 174 adapted to flex when pressure is applied thereto by a second connector member thereby allowing the second connector member to releasably connect thereto, wherein the first connector member 170 is attached to the rear surface of the semi-rigid panel of the main body; an adjustable handle 200 including a panel 210 that is rigid and elongated, a strap 220 that is elongated, adjustable in length, flexible, and connected to the panel at opposite ends thereof forming a loop, and wherein the strap is located on one side of the panel; a second connector member 180 attached to a second side of the panel opposite the strap, and is adapted to releasably and rotatably connect with the first connector member of the main body, wherein the adjustable handle 200 is adapted to releasably and rotatably connect with the main body 110, such that a user can place their hand within the adjustable handle to releasably and rotatably hold the case and thereby the electronic device within their hand.

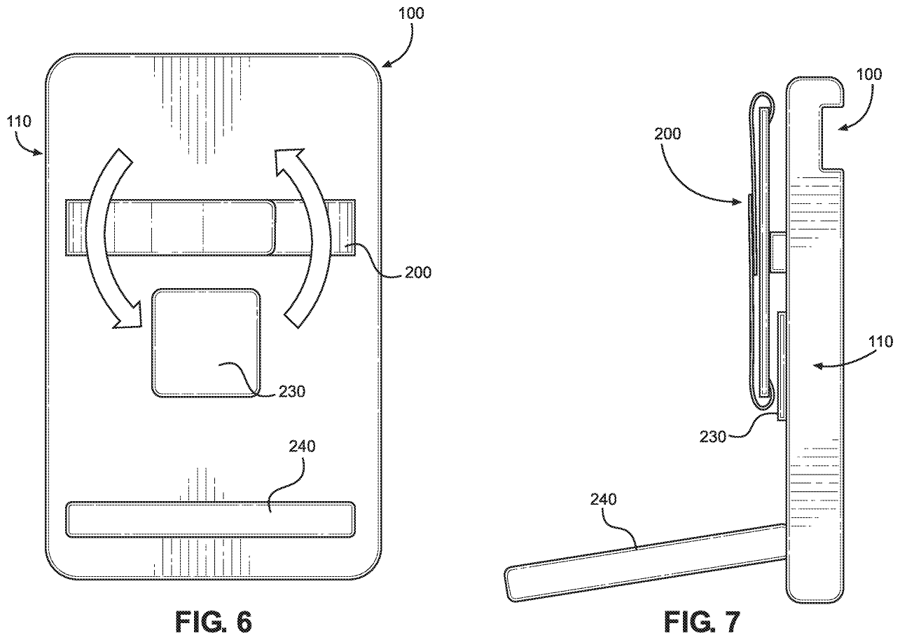

As illustrated in FIGS. 6 & 7, The phone case may further comprise a magnet 230 attached to the rear surface of the semi-rigid panel of the main body and is adapted to also releasably connect with the second connector member of the adjustable handle to thereby alternatively releasably and statically holding the adjustable handle to the main body.

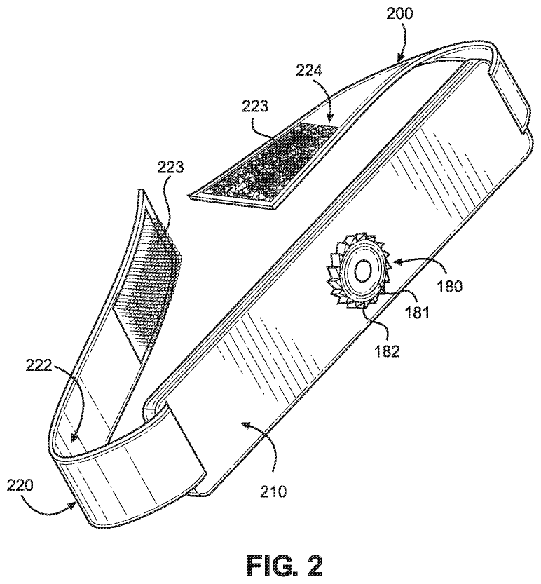

As illustrated in FIG. 2, the strap may include a first strap portion 222 having hook material 223 thereon; and a second strap portion 224 spaced from the first strap portion, is elongated, and includes loop material 225 thereon adapted to releasably connect with the loop material at a chosen position along its length thereby forming an adjustable loop. The strap 220 may also be formed from an elastic material thereby allowing the loop to change size.

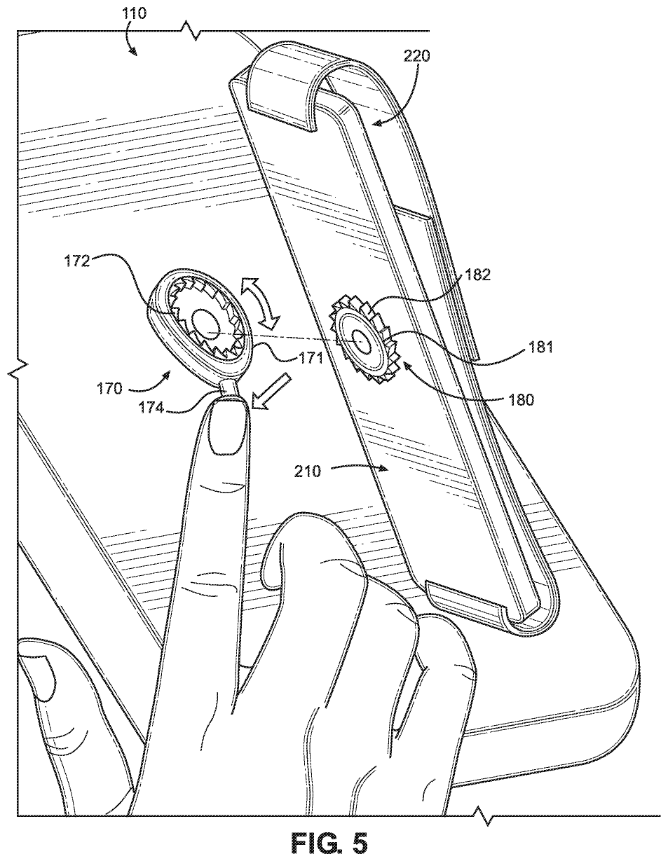

As illustrated in FIG. 5, the flexible portion 174 of the first connector member 170 may be formed to include a rectangular projection extending outwardly therefrom that is adapted to be pushed by a user's finger to aid in flexing the flexible portion when the second connector member is to be disconnected from the first connector member.

The first connector member 170 may be formed as a circular disk 171 having a radius and including a plurality of spaced ridges 172 upon an inner circumference thereof. The second connector member 180 may be formed as a circular disk 181 having a radius smaller than the radius of the circular disk of the first connector member and including a plurality of spaced, flexible, teeth 182 upon an outer circumference thereof, such that the plurality of spaced, flexible, teeth of the second connector member releasably engage respective ones of the plurality of spaced ridges of the first connector member thereby allowing the adjustable handle to be rotatably and securely adjusted with respect to the main body.

As illustrated in FIGS. 6 & 7, the phone case may further comprise a kick stand 240 pivotally connected to the rear surface of the semi-rigid panel of the main body and is adapted to hold the case in an upright position.

The semi-rigid panel may be formed from semi-rigid plastic, the first connector may be formed from a metallic material, and the second connector may be formed from a metallic material.

The instant case may be formed having dimensions including approximately 6″ in height, 3″ in width, and ¼″ in depth.

The instant case has an open face to allow easy view and operation of the smart phone's touchscreen, as well as a rear opening over the smart phone's camera lens. The case may also be produced in a variety of colors to appeal to individual tastes.

The case would provide a sturdy and simple means of securing a cellular smart phone to the person's hand without the person having to grip or intentionally hold the phone. Creatively appropriating a case and band combination, the case would ensure hand strain is a thing of the past, and that costly cellular equipment would not be broken or destroyed because of a potential fumble. heavy-duty, yet flexible, the adjustable band of the case could be positioned to comfortably fit virtually any hand size. As the phone itself would be within easy reach at all times, users would be able to receive and place calls, take instant video shots, and access messages in a matter of seconds. While the case was primarily conceived with popular phone brands in mind, any smart phone device would work this universal product, ensuring that costly smart phones are easily carried, held, accessed, and protected.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A case for holding an electronic device comprising:
a main body including:
a semi-rigid panel including:
a front surface;
a rear surface;
at least one side wall;
wherein said at least one side wall extends perpendicularly from said semi-rigid panel;
wherein said front surface and said at least one side wall form a rectangular volume; and
wherein said front surface and said at least one side wall are adapted to releasably and securely hold an electronic device within said rectangular volume;
a first connector member including:
a flexible portion;
wherein said flexible portion is adapted to flex when pressure is applied thereto by a second connector member thereby allowing said second connector member to releasably connect thereto;
wherein said first connector member is attached to said rear surface of said semi-rigid panel of said main body;
an adjustable handle including:
a panel;
wherein said panel is rigid and elongated;
a strap;
wherein said strap is elongated, adjustable in length, flexible, and connected to said panel at opposite ends thereof forming a loop; and
wherein said strap is located on one side of said panel;
a second connector member;
wherein said second connector member is attached to a second side of said panel opposite said strap, and is adapted to releasably and rotatably connect with said first connector member of said main body;
wherein said adjustable handle is adapted to releasably and rotatably connect with said main body, such that a user can place their hand within said adjustable handle to releasably and rotatably hold said case and thereby said electronic device within their hand.

2. The phone case of claim 1, further comprising a magnet attached to said rear surface of said semi-rigid panel of said main body and is adapted to releasably connect with said second connector member of said adjustable handle to thereby releasably and statically holding said adjustable handle to said main body.

3. The phone case of claim 1, wherein said strap includes:
a first strap portion;
wherein said first strap portion includes hook material thereon; and
a second strap portion;
wherein said second strap portion is spaced from said first strap portion, is elongated, and includes loop material thereon;
wherein said hook material is adapted to releasably connect with said loop material at a chosen position along its length thereby forming an adjustable loop.

4. The phone case of claim 1, wherein said strap is formed from an elastic material thereby allowing said loop to change size.

5. The phone case of claim 1, wherein said flexible portion of said first connector member is formed to include a rectangular projection extending outwardly therefrom, and is adapted to be pushed by a user's finger to aid in flexing said flexible portion when said second connector member is to be disconnected from said first connector member.

6. The phone case of claim 5, wherein said first connector member is formed as a circular disk having a radius and including a plurality of spaced ridges upon an inner circumference thereof; and wherein said second connector member is formed as a circular disk having a radius smaller than said radius of said circular disk of said first connector member and including a plurality of spaced, flexible, teeth upon an outer circumference thereof, such that said plurality of spaced, flexible, teeth of said second connector member releasably engage respective ones of said plurality of spaced ridges of said first connector member thereby allowing said adjustable handle to be rotatably and securely adjusted with respect to said main body.

7. The phone case of claim 1, further comprising a kick stand pivotally connected to said rear surface of said semi-rigid panel of said main body and is adapted to hold said case in an upright position.

8. The phone case of claim 1, wherein said semi-rigid panel is formed from semi-rigid plastic; wherein said first connector is formed from a metallic material; and wherein said second connector is formed from a metallic material.

9. A combination of an electronic device and a case for holding an electronic device, comprising:
an electronic device including:
a body;
wherein said body is formed having a rectangular volume; and
a case comprising:
a main body including:
a semi-rigid panel including:
a front surface;
a rear surface;
at least one side wall;
wherein said at least one side wall extends perpendicularly from said semi-rigid panel;
wherein said front surface and said at least one side wall form a rectangular volume; and
wherein said front surface and said at least one side wall are adapted to releasably and securely hold said electronic device within said rectangular volume;
a first connector member including:
a flexible portion;
wherein said flexible portion is adapted to flex when pressure is applied thereto by a second connector member thereby allowing said second connector member to releasably connect thereto;
wherein said first connector member is attached to said rear surface of said semi-rigid panel of said main body;
an adjustable handle including:
a panel;
wherein said panel is rigid and elongated;
a strap;
wherein said strap is elongated, adjustable in length, flexible, and connected to said panel at opposite ends thereof forming a loop; and
wherein said strap is located on one side of said panel;
a second connector member;
wherein said second connector member is attached to a second side of said panel opposite said strap, and is adapted to releasably and rotatably connect with said first connector member of said main body;
wherein said adjustable handle is adapted to releasably and rotatably connect with said main body, such that a user can place their hand within said adjustable handle to releasably and rotatably hold said case and thereby said electronic device within their hand.

10. The phone case of claim 9, further comprising a magnet attached to said rear surface of said semi-rigid panel of said main body and is adapted to releasably connect with said second connector member of said adjustable handle to thereby releasably and statically holding said adjustable handle to said main body.

11. The phone case of claim 9, wherein said strap includes:
a first strap portion;
wherein said first strap portion includes hook material thereon; and
a second strap portion;
wherein said second strap portion is spaced from said first strap portion, is elongated, and includes loop material thereon;
wherein said hook material is adapted to releasably connect with said loop material at a chosen position along its length thereby forming an adjustable loop.

12. The phone case of claim 9, wherein said strap is formed from an elastic material thereby allowing said loop to change size.

13. The phone case of claim 9, wherein said flexible portion of said first connector member is formed to include a rectangular projection extending outwardly therefrom, and is adapted to be pushed by a user's finger to aid in flexing said flexible portion when said second connector member is to be disconnected from said first connector member.

14. The phone case of claim 13, wherein said first connector member is formed as a circular disk having a radius and including a plurality of spaced ridges upon an inner circumference thereof; and wherein said second connector member is formed as a circular disk having a radius smaller than said radius of said circular disk of said first connector member and including a plurality of spaced, flexible, teeth upon an outer circumference thereof, such that said plurality of spaced, flexible, teeth of said second connector member releasably engage respective ones of said plurality of spaced ridges of said first connector member thereby allowing said adjustable handle to be rotatably and securely adjusted with respect to said main body.

15. The phone case of claim 9, further comprising a kick stand pivotally connected to said rear surface of said semi-rigid panel of said main body and is adapted to hold said case in an upright position.

16. The phone case of claim 9, wherein said semi-rigid panel is formed from semi-rigid plastic; wherein said first connector is formed from a metallic material; and wherein said second connector is formed from a metallic material.

17. The phone case of claim 9, wherein said electronic device is a smart phone.
